(19) United States
(12) Patent Application Publication
(10) Pub. No.: US 2021/0120830 A1
(43) Pub. Date: Apr. 29, 2021

(54) OUTDOOR COOKING ASSEMBLY

(71) Applicant: Joel W. Harris, Newville, AL (US)

(72) Inventor: Joel W. Harris, Newville, AL (US)

(21) Appl. No.: 16/665,829

(22) Filed: Oct. 28, 2019

(51) Int. Cl. A23B 4/052

(52) U.S. Cl. CPC A23B 4/052; A23V 2002/00

(57) ABSTRACT

An outdoor cooking assembly, has a smoker for smoking meat and a trailer having a frame, the frame having a mounting shaft, an angular side rail on one side of the mounting shaft and an angular side rail on the opposing side of the mounting shaft, the mounting shaft and the two angular side rails coupled to and integral with a support bar, the smoker rigidly and securely coupled to the frame.

### BACKGROUND

There are a variety of apparatuses on the market for smoking meat. These apparatuses are typically referred to as smokers. Some of these smokers use coals or smoke wood for fuel. Some smokers have gas burners, infrared or an electric heating source. A typical smoker can smoke briskets, pork shoulders, chicken pieces, Boston butts, and the like.

There are water smokers that are oriented vertically. The vertical water smokers typically have a porcelain-enameled lid and bowl and are comprised of three parts, including a bottom section that serves as the heat source. It comprises a middle compartment, which is just above the heat source, and comprises the water pan. The next chamber is a smoking chamber where the meat is placed atop a grate.

Box smokers are also vertically oriented. The box smoker works similarly to the water smoker including using a water bowl during the smoking process. There is a firebox at the bottom of the box smoker that houses the heat source. Above the heat source is often a water bowl. The box smoker comprises a plurality of racks on situated vertically upward and spaced apart so that meat may be smoked simultaneously on each rack.

There are drum smokers, which are also vertical smokers. A drum smoker comprises a firebox located at the center bottom, and a water bowl is positioned above the firebox. In the drum smoker there can be two or more cooking racks in the midsection and on the upper section as well.

There are many other types of vertical smokers. For example, there is a kamado grill that is vertically oriented and has an egg-shaped design. It works similar to the smokers described, there is a firebox on the bottom and grill grates and racks in the egg-shaped compartment. There is a smoker oven that is vertically oriented. A smoker oven is an insulated box with an electric heating element in the bottom. The smoker over has sealed doors. Above the heating element is a pan of wood chips that ignite during smoking.

Many individuals that own smokers enjoy participating in smoking competitions. These smoking competitions necessarily require the individual to move his/her smoker from the individual's home to the competition arena. Often, individuals transport their vertical smoker in the bed of a pickup truck or on a flatbed trailer. This may be difficult or onerous.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1. is a perspective view of a vertical smoker in accordance with an embodiment of the present disclosure.

FIG. 2 is a top plan view of the vertical smoker as depicted in FIG. 1.

FIG. 3 is a side plan view of the vertical smoker depicted in FIG. 1.

### DETAILED DESCRIPTION

The present disclosure describes an outdoor cooking assembly having a wood or charcoal fueling option. The outdoor cooking assembly of the present disclosure is rigidly coupled and secured to an elevated, outdoor cooking assembly carrier. The elevated, outdoor cooking assembly carrier is secured to a vehicle, e.g., a pickup truck, via a class III vehicle trailer hitch mount. The elevated, outdoor cooking assembly carrier to which the outdoor cooking assembly is secured comprises a vertically extending handle and an integral axle and wheel assembly. An individual may manually roll the vertical smoker using the handle. Further, the hitch mount can be mounted to the class III vehicle trailer receiver hitch so that the vertical smoker can be transported.

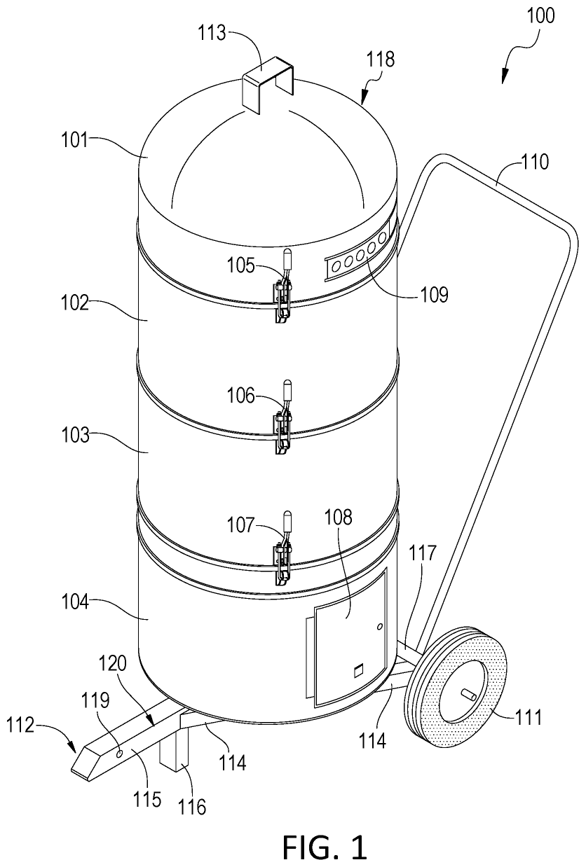

FIG. 1 is a perspective view of an outdoor cooking assembly 100 that comprises a smoker 118 that is mounted to an elevated, outdoor cooking assembly carrier 112 in accordance with an embodiment of the present disclosure. Notably, the outdoor cooking assembly 100 shown comprises a vertical smoker 118; however, other types of outdoor cooking assemblies may be possible in other embodiments of the present disclosure. For example, the outdoor cooking assembly 100 may comprise any type of horizontal smoker.

The vertical smoker 118 is rigidly coupled and secured to the elevated, outdoor cooking assembly carrier 112. In this regard, the smoker 118 may be welded to the elevated, outdoor cooking assembly carrier 112. Note that the vertical smoker 118 may be affixed to the elevated, outdoor cooking assembly carrier 112 using other methods in other embodiments.

The vertical smoker 118 comprises a firebox chamber 104. The firebox chamber 104 is accessible through a firebox access door 108 on the firebox chamber 104. The firebox chamber 104 houses the fuel, e.g., charcoal or smoke wood, that is used in the smoking process. Additionally, the vertical smoker 118 comprises at least two removeable cylindrical chambers 103 and 102 and a removeable, cylindrical, dome-shaped lid 101.

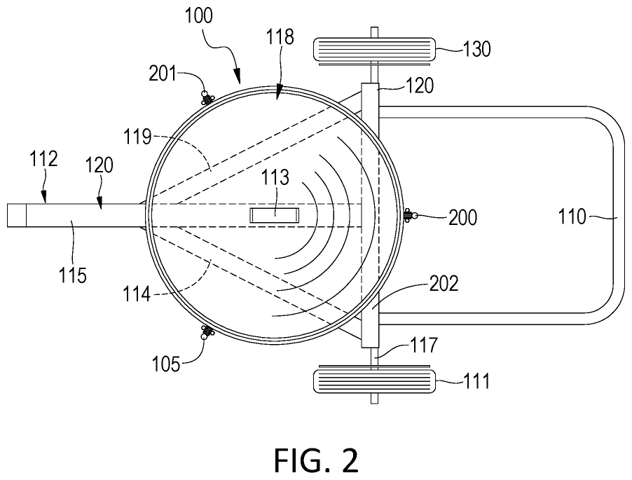

The firebox chamber 104 is removably coupled to the removeable, cylindrical chamber 103 via at least one latch 107. The removeable, cylindrical chamber 102 is removably coupled to the removeable, cylindrical chamber 103 via at least one latch 106. Further, the removeable, cylindrical, dome-shaped lid 101 is removably coupled to the removeable, cylindrical chamber 102 via at least one latch 105. Note that in one embodiment, the firebox chamber 104 is coupled to the removeable, cylindrical chamber 103 via a plurality of latches. Further note that the removeable, cylindrical chamber 103 is coupled to the removeable, cylindrical chamber 102 via a plurality of latches, and the removeable, cylindrical, dome-shaped lid 101 is removably coupled to the removeable, cylindrical chamber 102 via a plurality of latches. In one embodiment, the lid 101 and each chamber 102-104 is coupled to an adjacent chamber 101-103, respectively via three latches, which is shown herein with reference to FIG. 2.

In one embodiment, the removeable, cylindrical, dome-shaped lid 101 comprises an air vent 109. The air vent 109 allows air too to circulate through the vertical smoker 118 and aids in smoking of the meat.

There may be several racks (not shown) or grates (not shown) used within the vertical smoker 118. In this regard, there may be a rack or grate coupled to the removeable, cylindrical chamber 103 above the firebox chamber 104. Further, there may be a rack or grate coupled to the removeable, cylindrical chamber 102 above the removeable cylindrical chamber 103. There may also be a rack or grate coupled to the removeable, cylindrical, dome-shaped lid 101 above the removeable, cylindrical chamber 102. Meat may be placed on these various racks or grates for smoking.

Having a plurality of racks or grates in the vertical smoker 118 allows for simultaneous smoking of different meat. That is, meat may be placed on each rack or grate when the firebox chamber 104 is active. Meats may be strategically placed on the racks or grates depending upon the amount of time it takes to smoke a particular meat. In this regard, it may take less time to smoke chicken than a Boston butt, so the chicken may be placed on a rack or grate farther from the heat source than the Boston butt. In regards to vertical smoker 118, the chicken may be placed on a rack or grate coupled to the removeable, cylindrical, dome-shaped lid 101, and the Boston butt may be placed on a rack or grate coupled to removeable, cylindrical chamber 102 or removeable, cylindrical chamber 103 closer to the heat source in the firebox chamber 104.

As described, the vertical smoker 118 is rigidly and securely affixed to the elevated, outdoor cooking assembly carrier 112. The elevated, outdoor cooking assembly carrier 112 comprises a frame 120 to which the vertical smoker 118 is rigidly and securely coupled. Note that in one embodiment, the vertical smoker 118 is welded to the frame 120 of the elevated, outdoor cooking assembly carrier 112. Note that the vertical smoker 118 may be securely affixed to the elevated, outdoor cooking assembly carrier 112 in other ways in other embodiments.

The frame 120 comprises a central, mounting shaft 115 that extends under and is rigidly coupled to the underside of the vertical smoker 118. In one embodiment, the mounting shaft 115 may be steel tubing; however, it can be other shapes and made of other types of materials in other embodiments.

The mounting shaft 115 comprises an opening 119. The opening 119 is for receiving a hitch pin (not shown). In this regard, the mounting shaft 115 is inserted in a receiver tube (not shown) of a trailer hitch (not shown) coupled to a vehicle, e.g., a pickup truck. After the mounting shaft 115 is inserted in the receiver tube, a hitch pin is inserted through opening 119 and a corresponding opening in the receiver tube to couple the elevated, outdoor cooking assembly carrier 112 to the vehicle (not shown). In one embodiment, the mounting shaft 115 is inserted in a class III vehicle receiver hitch. The mounting shaft 115 may be inserted into other types of receiver hitches in other embodiments.

The frame 120 also comprises a foot 116. The foot 116 is coupled to the underside of the mounting shaft 115 and extends downward. When the trailer 112 is at rest, the foot 116 rests on the ground supporting the trailer 112.

The frame 120 further comprises two angled side rails, including side rail 114 on one side of the mounting shaft 115 and a second side rail (not shown) on the opposing side of the mounting shaft 115. The angled side rail 114 and the angled side rail (not shown) provide for further support of the vertical smoker 118. In one embodiment, the angled side rail 114 and the angled side rail (not shown) may be steel tubing; however, it can be other shapes and made of other types of materials in other embodiments.

The elevated, outdoor cooking assembly carrier 112 further comprises a first wheel 111 and a second wheel (not shown) coupled via an axle 117. Further, the elevated, outdoor cooking assembly carrier 112 comprises a handle 110. The handle 110 extends from one side of the frame 120 to the other rectangularly and at an angle relative to the vertical smoker 118. In use, an individual grasps the handle 110. The individual leans the elevated, outdoor cooking assembly carrier 112 back toward the individual such that the foot 116 is no long touching the ground. The individual can then transport the vertical smoker 118 on the first wheel 111 and the second wheel (not shown) by pushing or pulling the assembly 100.

FIG. 2 is a top plan view of the outdoor cooking assembly 100. The outdoor cooking assembly 100 comprises the vertical smoker 118. The vertical smoker 118 is rigidly and securely affixed to the elevated, outdoor cooking assembly carrier 112.

In this regard, the elevated, outdoor cooking assembly carrier 112 comprises the frame 120. The frame 120 comprises the mounting shaft 115 and a support bar 202. The mounting shaft 115 extends from in front of the vertical smoker 118 to the support bar 202. The mounting shaft 115 couples to and is integral with the support bar 202. In one embodiment, the support bar 202 is made of steel tubing; however, the support bar 202 may be other shapes or made of other materials in other embodiments.

The frame 120 further comprises the angled side rail 114 and an angled side rail 119. The angled side rail 114 extends angularly and outwardly from the mounting shaft 115 to the support bar 202. The angled side rail 114 is coupled to and integral with the mounting shaft 115 and the support bar 202. The angled side rail 119 mirrors angled side rail 114. In this regard, the angled side rail 119 extends angularly and outwardly from the mounting shaft 115 to the support bar 202. The angled side rail 119 is coupled to and integral with the mounting shaft 115. Further, the angled side rail 119 is coupled to and integral with the support bar 202. In one embodiment, the angled side rail 114 and the angled side rail 119 may be steel tubing; however, it can be other shapes and made of other types of materials in other embodiments.

The elevated, outdoor cooking assembly carrier 112 further comprises the handle 110. The handle 110 couples on one side of the vertical smoker 118 to the support bar 202. Also, the handle 110 couples on the other side of the vertical smoker 118 to the support bar 202. The handle 110 extends at an angle vertically from the support bar 202. The handle 110 may be used to transport the smoker 118 when not attached to a receiver hitch.

Coupled to the frame 120 is the integral axle 117. The axle 117 connects wheel 111 to wheel 130. In use, an individual can grasp the handle 110, tilt the trailer 112 backward, and transport the trailer on the wheels 111 and 130.

Note that FIG. 2 shows a top plan view of the outdoor cooking assembly 100. As noted herein, the removeable, cylindrical, dome-shaped lid 101 (FIG. 1) is removably coupled to the removeable, cylindrical chamber 102 (FIG. 1) via a plurality of latches. Thus, FIG. 2 shows the latch 105, a latch 200, and a latch 201 that couple the removeable, cylindrical, dome-shaped lid 101 to the removeable, cylindrical chamber 102 (FIG. 1).

The vertical smoker 118 further comprises a handle 113. An individual can use the handle to lift the removeable, cylindrical, dome-shaped lid 101 (FIG. 1) once the removeable, cylindrical, dome-shaped lid 101 has been unlatched from the removeable, cylindrical chamber 102 (FIG. 1).

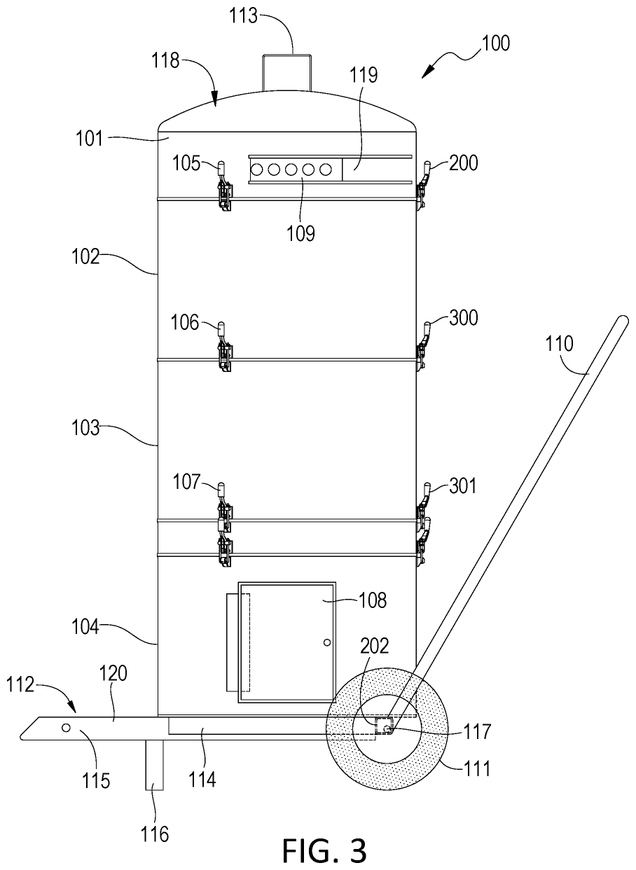

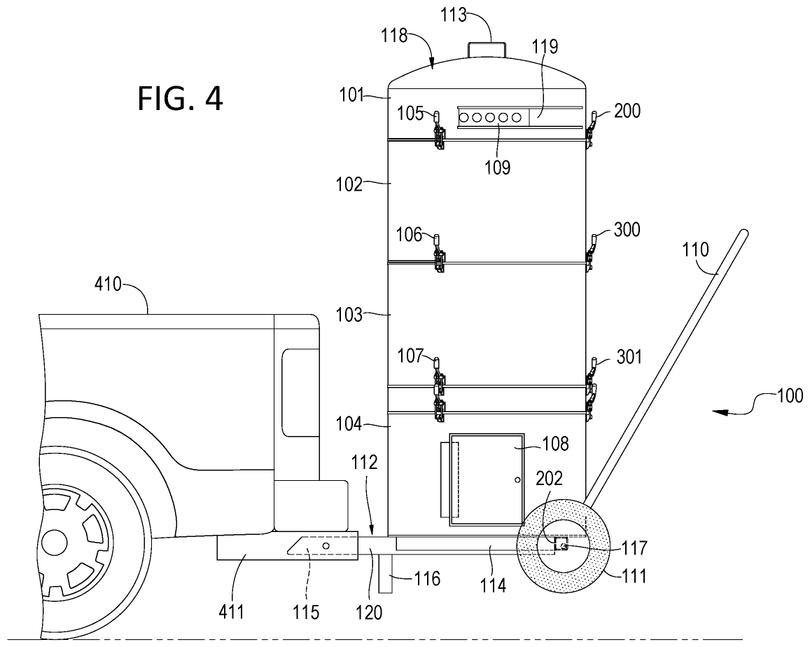

FIG. 3 is a side plan view of the outdoor cooking assembly 100. The side plan view of FIG. 3 shows the vertical smoker 118 rigidly and securely affixed to the elevated, outdoor cooking assembly carrier 112. In particular, the vertical smoker 118 is affixed to the frame 120. In this regard, the frame comprises the mounting shaft 115, the two angular side rails 114 and 119 (FIG. 2), and the support bar 202 that extends across the axle 117 that couples the wheel 111 with the wheel on the other side (not shown). The frame 120 comprises a foot 116 that steadies the outdoor cooking assembly 100 when it is not in transport.

In transport, an individual grasps the handle 110, tilts the outdoor cooking assembly 100 toward the individual, which lifts the outdoor cooking assembly off the ground at the front of the outdoor cooking assembly 100. Via the wheel 111 and the other wheel (not shown), the individual can transport the outdoor cooking assembly 100 when the elevated, outdoor cooking assembly carrier 112 is not attached to a receiver hitch.

As noted, the firebox chamber 104 houses the fuel, i.e., the charcoal or smoke wood. The firebox chamber 104 is coupled via latches 107 and 301 to the removeable, cylindrical chamber 103 that may comprise a water bowl, a rack, or a grate. The removeable, cylindrical chamber 103 is coupled via latches 106 and 300 to the removeable, cylindrical chamber 102, and the removeable, cylindrical chamber 102 is coupled via latches 105 and 200 to the removeable, cylindrical, domed lid 101. While only two latches are shown, in one embodiment, the chambers are secured with three latches.

FIG. 4 is a side view depicting the outdoor cooking assembly 100 coupled to a vehicle 410 for transporting the outdoor cooking assembly 100. The mounting shaft 115 is inserted in a class III vehicle receiver hitch 411. Note that it may be other types of hitches in other embodiments.

As shown, the mounting shaft 115 coupled with the side rail 114 and the opposing side rail (not shown) provide support to maintain the smoker 118 in an elevated position of ground. In the elevated position, the elevated, outdoor cooking assembly carrier 112 coupled to the smoker 118 may be transported behind a vehicle, e.g., a truck, with a receiver hitch, e.g., a class III vehicle receiver hitch.

What is claimed is:

1. An outdoor cooking assembly, comprising:
a smoker for smoking meat;
a trailer comprising a frame, the frame comprising a mounting shaft, an angular side rail on one side of the mounting shaft and an angular side rail on the opposing side of the mounting shaft, the mounting shaft and the two angular side rails coupled to and integral with a support bar, the smoker rigidly and securely coupled to the frame.

2. The outdoor cooking assembly of claim 1, wherein the smoker is a vertical smoker.

3. The outdoor cooking assembly of claim 2, wherein the vertical smoker comprises a firebox chamber and at least one removeable, cylindrical chamber.

4. The outdoor cooking assembly of claim 3, wherein the firebox chamber comprises a door for inserting fuel.

5. The outdoor cooking assembly of claim 4, the firebox chamber is coupled to the removeable, cylindrical chamber with at least one latch.

6. The outdoor cooking assembly of claim 1, wherein the frame is coupled to a handle.

7. The outdoor cooking assembly of claim 6, wherein the handle extends vertically upward from the frame.

8. The outdoor cooking assembly of claim 7, wherein the handle is substantially rectangular-shaped.

9. The outdoor cooking assembly of claim 1, wherein the frame is coupled to an axle and the axle has a wheel on each side.

10. The outdoor cooking assembly of claim 1, wherein the frame comprises a foot that extends from the mounting shaft to the ground to steady the outdoor cooking assembly.

11. The outdoor cooking assembly of claim 1, wherein the mounting shaft comprises an opening.

12. The outdoor cooking assembly of claim 11, wherein the mounting shaft is configured to be received by a receiving hitch and a hitch pin is inserted through the opening.

13. The outdoor cooking assembly of claim 1, wherein the mounting shaft is configured to be inserted in a class III vehicle trailer receiver hitch.

14. An outdoor cooking assembly, comprising:
a vertical smoker having a firebox chamber, a removeable, cylindrical chamber, and a removeable, cylindrical dome-shaped lid, the firebox chamber removably coupled to the removeable, cylindrical chamber and the removeable, cylindrical chamber coupled to the removeable, cylindrical dome-shaped lid; and
a trailer comprising a handle and wheels, the vertical smoker rigidly and securely coupled to the trailer.

15. The outdoor cooking assembly of claim 14, wherein the trailer comprises a frame.

16. The outdoor cooking assembly of claim 15, wherein the frame comprises a mounting shaft and angular side rails on either side of the mounting shaft.

17. The outdoor cooking assembly of claim 16, wherein the mounting shaft and the angular side rails coupled to and are integral with a support bar.
